(19) United States
(12) Patent Application Publication
(10) Pub. No.: US 2008/0116787 A1
(43) Pub. Date: May 22, 2008

(54) PIXEL STRUCTURE OF ACTIVE MATRIX ORGANIC LIGHT EMITTING DISPLAY AND FABRICATION METHOD THEREOF

(75) Inventors: Shien-Chi Hsu, Hsinchu (TW); Chin-Yuan Lin, Hsinchu (TW); Wei-Sheng Yu, Hsinchu (TW); Yi-Jun Lu, Hsinchu (TW); Shu-Ching Hsu, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: AU OPTRONICS CORPORATION, Hsinchu (TW)

(21) Appl. No.: 11/684,011

(22) Filed: Mar. 9, 2007

(30) Foreign Application Priority Data
Nov. 17, 2006 (TW) 95142537

(51) Int. Cl. H01J 1/62; H01J 9/00

(52) U.S. Cl. 313/504; 445/24

(57) ABSTRACT

A pixel structure of active matrix organic light emitting display and method for fabricating the same are provided. In the method, a transparent electrode, an organic light emitting diode, and a reflective electrode are formed on a substrate. Subsequently, at least one switching thin film transistor, at least one driving thin film transistor, a scan line, a data line, and a storage capacitor are formed over the substrate.

### CROSS-REFERENCE TO RELATED APPLICATION

This application claims the priority benefit of Taiwan application serial no. 95142537, filed Nov. 17, 2006. All disclosure of the Taiwan application is incorporated herein by reference.

### BACKGROUND OF THE INVENTION

1. Field of the Invention

The present invention relates to an active matrix organic light emitting display (AMOLED) and more particularly, a thin film transistor disposed on the light emitting diode (LED) of the pixel structure of active matrix organic light emitting display and fabrication method thereof.

2. Description of Related Art

An organic light emitting diode is a semiconductor device that transforms electrical energy to light energy. It is known for its high luminescent efficiency, wide range of viewing angle, simple manufacturing process, low manufacturing cost, high response speed, wide operating temperature range and full color. These advantages of organic light emitting diode (OLED) overlap with many of the desired characteristics of today's multi-media displays. As a result, OLEDs are widely used in applications such as indicator lights and luminescent devices of displays.

The early OLED displays are driven by the passive driving method. Nevertheless, the luminescent efficiency and the longevity of the passive driving device drastically decline as the size and the resolution of the display increases. Hence, AMOLED display has become the main direction of development in display technology.

Moreover, different OLED displays require different full color techniques. Currently, the major full color techniques include: (1) Using only Red/Green/Blue (R/G/B) OLEDs, (2) Using a blue OLED as the light source with a color changing medium (CCM) and (3) Using a white OLED as the light source with a color filter (CF). Herein, the full color technique using R/G/B OLEDs provides a better luminescent efficiency. Therefore, it is the most frequently used full color technique.

An AMOLED display comprises a plurality of AMOLED pixel structures, wherein comprising an anode, an OLED, a cathode, a scan line, a data line, a switching thin film transistor (switching TFT), a driving thin film transistor (driving TFT) and a storage capacitor. FIG. 1A through FIG. 1C are schematic cross-sectional views illustrating the pixel structures of three conventional AMOLED displays. A brief discussion about the history of AMOLED display based on FIG. 1A through FIG. 1C is as followed. Further, it should be noted that some components are omitted from FIG. 1A through FIG. 1C because the following explanation mainly directs to OLEDs and driving TFTs.

First, in FIG. 1A, a pixel structure of AMOLED display 100 is top-emitting type, wherein comprising a substrate 110, a driving TFT 120 and an OLED 130. The pixel structure of AMOLED display 100 has the emitting direction 140. Moreover, the OLED 130 comprises a cathode 132, an organic emitting layer 134 and an anode 136; The cathode 132 is fabricated using materials such as aluminium while the anode 136 is fabricated using materials such as indium tin oxide (ITO). In addition, the cathode 132 and the driving TFT 120 are electrically connected

FIG. 1A shows the fabrication process of the pixel structure of AMOLED display 100 sequentially forming the driving TFT 120, the cathode 132, the organic emitting layer 134 and the anode 136.

However, the anode 136 is usually fabricated by sputtering. As a result, the formation of the anode 136 often damages the organic emitting layer 134.

To prevent the organic emitting layer 134 from being damaged, U.S. Pat. No. 6,853,134 provides a solution that is illustrated by FIG. 1B. In FIG. 1B, after the formation of the organic emitting layer 134, prior to the formation of the anode 136, a very thin gold film 145 is formed on the organic emitting layer 134 and the materials forming the gold film 145 is either gold or gold alloy. Due to the presence of the gold film 145, the organic emitting layer. 134 can be prevented from being damaged by the sputtering process for forming the anode 136. However, the gold film 145 shields light, drastically decreasing the light transmission rate of the pixel structure of AMOLED display 100. With the presence of the gold film 145, the light transmission rate is merely 30% of the original rate.

In FIG. 1C, the driving TFT 120 is electrically connected to the cathode 132 and the anode 136 is disposed on the other side of the organic emitting layer 134. Under the circumstances, the pixel structure of AMOLED display 100 is bottom-emitting type and has an emitting direction 150. As illustrated in FIG. 1C, the driving TFT 120 shields light, thus decreasing the aperture ratio of the pixel structure of AMOLED 100.

### SUMMARY OF THE INVENTION

The present invention is related to a fabrication method for the pixel structure of active matrix organic light emitting diode (AMOLED) display to minimize the damage to the organic emitting layer caused by the sputtering process.

The present invention is further related to a pixel structure of AMOLED display having a better light transmission rate and aperture ratio.

In order to achieve the above or other advantages, the present invention provides a fabrication method for the pixel structure of AMOLED display. This method comprises steps (a) and (b). In step (a), an OLED is formed on a substrate, which comprises a transparent electrode, an organic emitting layer and a reflective electrode. Further, the organic emitting layer is disposed between the transparent electrode and the reflective electrode. In step (b), at least one switching TFT, at least one driving TFT, a scan line, a data line, and a storage capacitor are formed over the substrate, wherein the switching TFT comprises a first gate, a first source and a first drain. The first gate is coupled to the scan line, and the first source is coupled to the data line. The driving TFT comprises a second gate, a second source and a second drain. The second gate is coupled to the first drain. The storage capacitor is electrically connected to the first drain and the second gate. The second drain is coupled to the reflective electrode.

In one embodiment of the present invention, the fabrication method for the channel layer of the driving TFT and the switching TFT begins with forming a silicon layer by inductively coupled plasma chemical vapor deposition (ICP-CVD),. Next, the silicon layer is crystallized by the excimer laser annealing (ELA) to form a polysilicon layer.

In one embodiment of the present invention, the fabrication parameters for the said ICP-CVD include an operating temperature of 100° C. to 200° C. and an operating pressure of 10 mTorr (mT) to 30 mT. Additionally, the reaction gases used in the fabrication method are helium and silane (SiH₄) and the ratio of helium to silane ranges from 15:3 to 25:3.

In one embodiment of the present invention, before the step (a), a changing color medium or a color filter is formed on the substrate.

In one embodiment of the present invention, the second gate is formed before the formation of the second source and the second drain.

In one embodiment of the present invention, the second gate is formed after the formation of the second source and the second drain.

In one embodiment of the present invention, the transparent electrode, the organic emitting layer and the reflective electrode are fabricated sequentially.

In one embodiment of the present invention, after the step (a) but before the step (b), an insulation layer is formed over the substrate.

In one embodiment of the present invention, the insulation layer is fabricated using benzocyclobutene (BCB)

In one embodiment of the present invention, the fabrication method for the insulation layer includes forming an insulation material layer over the substrate by spin coating. Then, the insulation material layer goes through thermal curing.

In one embodiment of the present invention, before the step (b), a buffer layer is formed on the insulation layer

In one embodiment of the present invention, the buffer layer is fabricated using silicon nitride.

In order to achieve the above or other advantages, the present invention provides a pixel structure of AMOLED display which can be fabricated according to the above fabrication method. This pixel structure of AMOLED display comprises a substrate, an OLED, a scan line, a data line, at least one switching TFT, at least one driving TFT, and a storage capacitor. The OLED comprises a transparent electrode, a reflective electrode and an organic emitting layer, wherein the transparent electrode is disposed between the substrate and the organic emitting layer while the organic emitting layer is disposed between the transparent electrode and the reflective electrode. The switching TFT comprises a first gate, a first source and a first drain, wherein the first gate is coupled to the scan line and the first source is coupled to the data line. The driving TFT comprises a second gate, a second source, and a second drain, wherein the second gate is coupled to the first drain and the second drain is coupled to the reflective electrode. The storage capacitor is electrically connected to the first drain and the second gate.

In one embodiment of the present invention, the channel layer of the switching TFT and the driving TFT is a polysilicon layer.

In one embodiment of the present invention, the pixel structure of AMOLED display further comprises either a color changing medium or a color filter that is disposed between the substrate and the transparent electrode.

In one embodiment of the present invention, the second gate is disposed below and between the second source and the second drain.

In one embodiment of the present invention, the second gate is disposed above and between the second source and the second drain.

In one embodiment of the present invention, the pixel structure of AMOLED display further comprises an insulation layer that is disposed between the organic emitting layer and the driving TFT as well as between the reflective electrode and the driving TFT.

In one embodiment of the present invention, the insulation layer is fabricated using benzocyclobutene (BCB)

In one embodiment of the present invention, the pixel structure of AMOLED display further comprises a buffer layer that is disposed between the insulation layer and the driving TFT.

In one embodiment of the present invention, the buffer layer is fabricated using silicon nitride.

The fabrication method for the pixel structure of AMOLED display of the present invention begins with the formation of OLED followed by the formation of TFT, and the pixel structure is bottom-emitting type. As a result, the light emitted by the OLED will not pass through the TFT, thus greatly increasing the aperture ratio. Furthermore, since the transparent electrode, the organic emitting layer and the reflective electrode are fabricated sequentially, the organic emitting layer is prevented from being damaged by the formation of the transparent electrode while retaining the light transmission rate of OLED.

In order to the make the aforementioned features and advantages of the present invention comprehensible, a preferred embodiment accompanied with figures are described in detail below.

### BRIEF DESCRIPTION OF THE DRAWINGS

FIG. 1A through FIG. 1C are schematic cross-sectional views illustrating the pixel structures of three conventional AMOLED display.

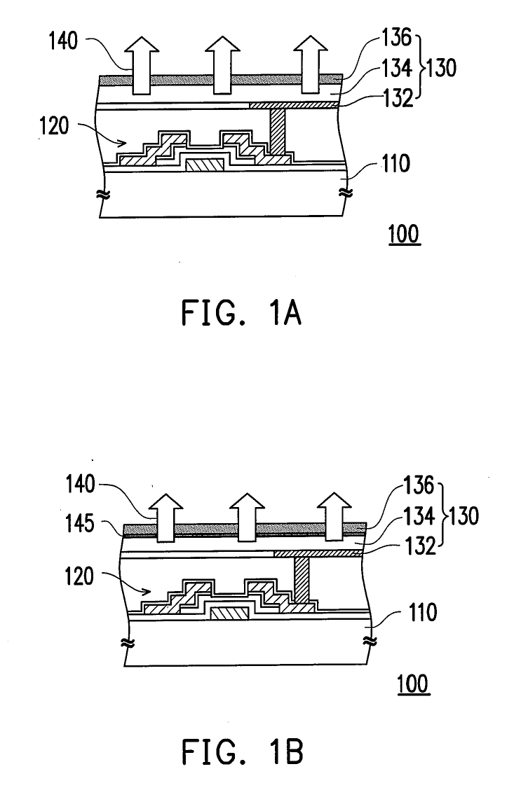

FIG. 2 is a schematic view illustrating the circuit of the pixel structure of AMOLED display according to an embodiment of the present invention

FIG. 3A through FIG. 3C are cross-sectional views illustrating the fabrication method of the pixel structure shown in FIG. 2.

FIG.4 is a cross-sectional view illustrating the pixel structure of AMOLED display according to an embodiment of the present invention.

### DESCRIPTION OF EMBODIMENTS

To solve the problems encountered by the conventional technology, the present invention provides a fabrication method for the pixel structure of AMOLED display and the pixel structure of AMOLED display. This fabrication method begins with the formation of OLED first, followed by the formation of TFT. The pixel structure disclosed by the present invention is similar to the structure of the thin film transistor array on color filter (TFT-array on color filter, TOC or AOC) used in liquid crystal display (LCD).

Generally, the channel of TFT is fabricated using amorphous silicon or polysilicon, wherein polysilicon demonstrates better electron mobility. Therefore, TFT utilizing a polysilicon channel provides a better device performance. Nonetheless, the temperature for fabricating polysilicon is usually above 300° C. Since OLED cannot withstand the high temperature for fabricating polysilicon channel layer, the structure of OLED is damaged as a result of the formation of the polysilicon channel layer. Nevertheless, the present invention provides a fabrication method that can prevent the aforesaid result, allowing TFT to be disposed on the structure of OLED without damages. In the following, the pixel structure of AMOLED display and the method for fabricating the same are disclosed in detail.

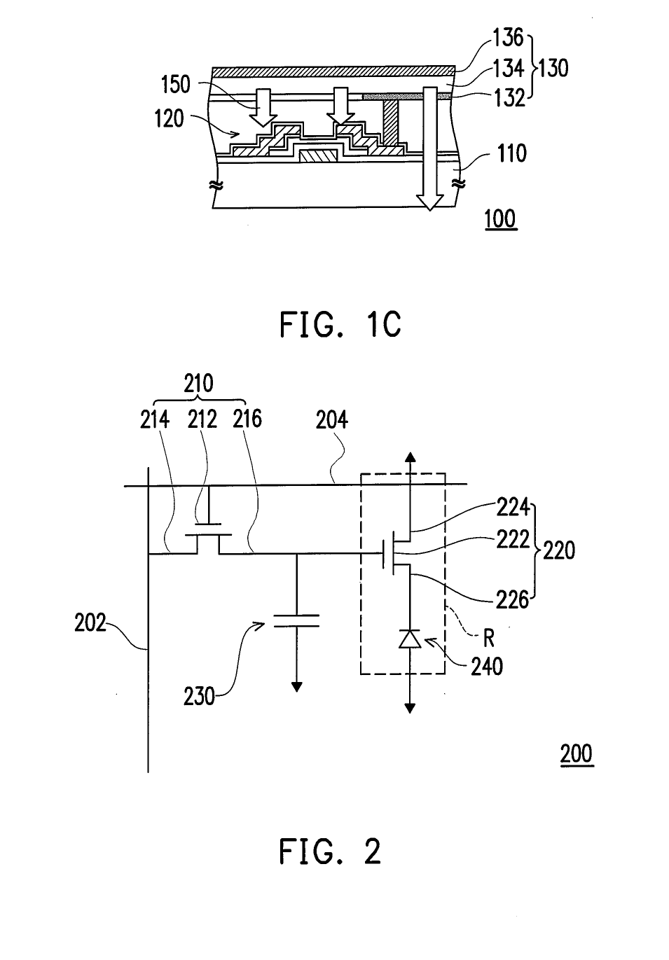

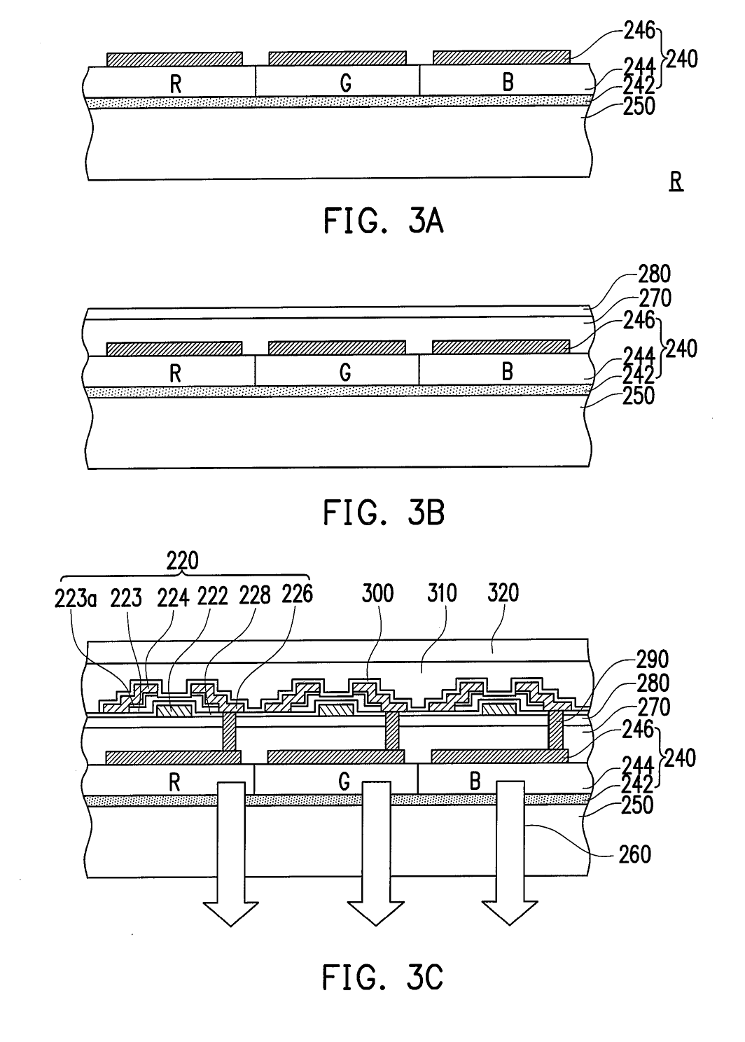

FIG.2 is a schematic view illustrating the circuit of the pixel structure of AMOLED display 200 according to an embodiment of the present invention. FIG. 3A through FIG. 3C are cross-sectional views illustrating the fabrication method of the pixel structure 200, wherein FIG. 3C is the cross-sectional view of the pixel structure 200 shown in FIG. 2. However, to emphasize the key features of the present invention, FIG. 3C merely illustrates the components in the region labeled R on FIG. 2.

In FIG. 2 and FIG. 3C, the pixel structure 200 comprises a data line 202, a scan line 204, at least one switching TFT 210, at least one driving TFT 220, a storage capacitor 230, an OLED 240 and a substrate 250. The switching TFT 210 comprises a first gate 212, a first source 214 and a first drain 216, wherein the first gate 212 is coupled to the scan line 204 and the first source 214 is coupled to the data line 202. The driving TFT 220 comprises a second gate 222, a second source 224 and a second drain 226, wherein the second gate 222 is coupled to the first drain 216.

Furthermore, the driving TFT 220 further comprises a channel layer 223 and an ohmic contact layer 223a. The channel layer 223 is fabricated using materials such as polysilicon while the ohmic contact layer 223a is fabricated using materials such as doped polysilicon. The switching TFT 210 also comprises a channel layer (not shown) and an ohmic contact layer (not shown) and the materials for each can also be polysilicon and doped polysilicon. In addition, the pixel structure 200 usually further comprises a passivation layer 300, a planarization layer 310 and a substrate 320. The passivation layer 300 is fabricated using materials such as silicon nitride. The planarization layer 310 is fabricated using, for instance, photoresist materials or organic materials. Anyone skilled in the art will be familiar with the construct and the functionality of the passivation layer 300, the planarization layer 310 and the substrate 320, which will not be further described.

Moreover, the storage capacitor 230 is electrically connected to the first drain 216 and the second gate 222. The OLED 240 comprises a transparent electrode 242, an organic emitting layer 244 and a reflective electrode 246, wherein the transparent electrode 242 is disposed between the substrate 250 and the organic emitting layer 244 while the organic emitting layer 244 is disposed between the transparent electrode 242 and the reflective electrode 246. As shown FIG. 3C, the pixel structure 200 has an emitting direction 260. In other words, the pixel structure 200 is a bottom-emitting type pixel structure.

FIG. 3C also shows that the pixel structure 200 of the present invention can realize all kinds of full color techniques. In the present embodiment, the pixel structure 200 comprises three OLEDs 240 and each of them respectively comprises a red light organic emitting layer R, a green light organic emitting layer G, or a blue light organic emitting layer B. These three OLEDs 240 are electrically connected to the second drains 226 of three driving TFTs 220 respectively.

Furthermore, in another embodiment, the pixel structure 200 comprises at least one OLED 240 and a color changing medium (CCM) (not shown), wherein the CCM is disposed between the substrate 250 and the transparent electrode 242. Under such circumstances, the OLED 240 utilizes the blue light OLED. In yet another embodiment, the pixel structure 200 comprises at least one OLED 240 and a color filter (not shown), wherein the color filter is disposed between the substrate 250 and the transparent electrode 242. Under such circumstances, the OLED 240 utilizes the white light OLED.

The pixel structure 200 of the present invention is a structure formed by a type of TFT disposed on OLED and this structure is not limited by the types of TFT. In FIG. 3C, according to the present embodiment, the driving TFT 220 is a bottom-gate TFT, wherein the second gate 222 is disposed below and between the second source 224 and the second drain 226.

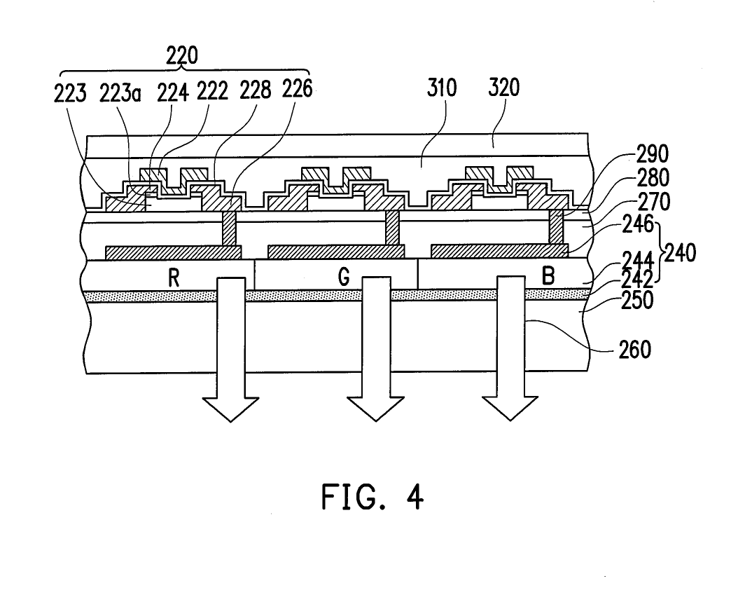

According to the present embodiment, the second gate 222 is formed first during the fabrication process of the driving TFT 220. Nevertheless, the driving TFT 220 can also be fabricated as a top-gate TFT as shown in FIG. 4, wherein FIG. 4 is another embodiment of the present invention illustrating the cross-sectional view of the pixel structure 200 of AMOLED display. In FIG. 4, the second gate 222 is disposed above and between the second source 224 and the second drain 226. According to this embodiment, the second gate 222 is formed last during the fabrication process of the driving TFT 220.

In FIG. 3C and FIG. 4, according to the present embodiment, the pixel structure 200 further comprises an insulation layer 270, which is disposed between the organic emitting layer 244 and the driving TFT 220 as well as between the reflective electrode 246 and the driving TFT 220. The insulation layer 270 is fabricated using benzocyclobutene (BCB). The functionalities of the insulation layer 270 comprise: electrically isolating the driving TFT 220 and the OLED 240, and acting as a planarization layer during the fabrication process of the pixel structure 200 to planarize the uneven surface formed by the organic emitting layer 244 and the reflective electrode 246 to ensure the driving TFT 220 is formed on an even surface.

On the other hand, according to the present embodiment, the pixel structure 200 further comprises a buffer layer 280 which is disposed between the insulation layer 270 and the driving TFT 220. The buffer layer 280 is fabricated using materials such as silicon nitride. The functionality of the buffer layer 280 is to prevent the layers beneath it from being chemically attacked during the fabrication of the second gate 222. Moreover, another functionality of the buffer layer 280 is to provide good adhesion to the layers subsequently formed and the layers beneath it. Furthermore, the pixel structure 200 further comprises a contact 290 which is disposed in the insulation layer 270 and the buffer layer 280 to electrically connect the second drain 226 and the reflective electrode 246 as shown in FIG. 3C.

Since the driving TFT 220 is bottom-gate type, the contact 290 must be inserted into the gate insulation layer 228. Nevertheless, if the pixel structure employs the top gate type driving TFT 220, the contact 290 does not need to be inserted into the gate insulation layer 228. Therefore, employing a top gate type driving TFT 220 can increase the fabrication tolerance of the contact 290. In other words, when a top gate type driving TFT 220 is used, the fabrication process of the contact 290 can be simplified.

The fabrication method for the pixel structure 200 is explained with the help of FIG. 2 and FIG. 3A through FIG. 3C as follows. However, it should be noted that the following fabrication method to be described is merely an example to illustrate the process of producing the pixel structure 200, which is not intended to limit the scope of the present invention

First, in FIG. 3A, a substrate 250 is provided. Next, an OLED 240 is formed on the substrate 250, which comprises a transparent electrode 242, an organic emitting layer 244 and a reflective electrode 246. The organic emitting layer 244 is disposed between the transparent electrode 242 and the reflective electrode 246. In the present embodiment, the transparent electrode 242, the organic emitting layer 244 and the reflective electrode 246 are fabricated sequentially to form a bottom-emitting type pixel structure 200. In addition, the transparent electrode 242 is fabricated using indium tin oxide (ITO) and the fabrication method thereof is sputtering. Under such circumstances, the organic emitting layer 244 is prevented from being damaged by the sputtering process since the transparent electrode 242 is formed on the substrate 250 prior to the fabrication of the organic emitting layer 244.

Moreover, according to another embodiment, a color changing medium (CCM) (not shown) is formed on the substrate 250 prior to the fabrication of the OLED 240. Under such circumstances, the OLED 240 is, for instance, a blue light OLED that emits light towards the substrate 250 and uses the CCM to vary the wavelength of the light it emits to achieve the effects of full color. In yet another embodiment, a color filter (not shown) is formed on the substrate 250 prior to the fabrication of the OLED 240. Under such circumstances, the OLED 240 -is, for instance, a white light OLED that emits light towards the substrate 250 and uses the color filter to vary the wavelength of the light it emits to achieve the effects of fill color.

Next, in FIG. 3B, the pixel structure of the present embodiment further comprises an insulation layer 270 forming over the substrate 250. The insulation layer 270 is fabricated using materials such as benzocyclobutene (BCB). Further, the fabrication method of the insulation layer 270 begins, for instance, with forming an insulation material layer (not shown) over the substrate 250 by spin coating. Then, the insulation material layer goes through thermal curing to form the insulation layer 270. One functionality of the insulation layer 270 is to electrically isolate the OLED 240 and the driving TFT 220 that is subsequently formed. Another functionality of the insulation layer 270 is to planarize the uneven surface formed by the organic emitting layer 244 and the reflective electrode 246 to ensure the driving TFT 220 is disposed on an even surface.

In addition, after the formation of the insulation layer 270, a buffer layer 280 can be formed on the insulation layer 270. The buffer layer 280 is fabricated using materials such as silicon nitride. The fabrication method of the buffer layer 280 is, for instance, plasma-enhanced chemical vapor deposition (PECVD). The functionality of the buffer layer 280 is to prevent the layers beneath it from being chemically attacked during the fabrication of the second gate 222. Moreover, another functionality of the buffer layer 280 is to provide good adhesion to the layers subsequently formed and the layers beneath it. It should be noted that the fabrication of the insulation layer 270 and the buffer layer 280 is optional. In other words, in another embodiment, the pixel structure 200 of the present invention does not need to include the insulation layer 270 and the buffer layer 280.

Next, in FIG. 2 and FIG. 3C, at least one switching TFT 210, at least one driving TFT 220, a scan line 204, a data line 202, and a storage capacitor 230 are formed over the substrate 250. The switching TFT 210 comprises a first gate 212, a first source 214 and a first drain 216, wherein the first gate 212 is coupled to the scan line 204 and the first source 214 is coupled to the data line 202. Moreover, the driving TFT 220 comprises a second gate 222, a second source 224 and a second drain 226, wherein the second gate 222 is coupled to the first drain 216. The storage capacitor 230 is electrically connected to the first drain 216 and the second gate 222. The second drain 226 is coupled to the reflective electrode 246.

The fabrication methods for the components are similar to that of the conventional TFT array substrate, which will not be further described in details.

As described above, the switching TFT 210 has a channel layer (not shown) and the driving TFT 220 also has a channel layer 223. It should be noted that both the switching TFT 210 and the driving TFT 220 must be the low-temperature poly-Si (LTPS) TFT. In other words, the channel layers of the switching TFT 210 and the driving TFT 220 have to be fabricated at a temperature that is below 200° C. As a result, the OLED 240 is prevented from withstanding high process temperature.

In the present embodiment, the fabrication method for the channel layer of the switching TFT 210 and the driving TFT 220 begins with ICP-CVD to form a silicon layer (not shown). Then, excimer laser annealing (ELA) is used to crystallize this silicon layer, resulting in the formation of a polysilicon layer. Moreover, the fabrication parameters for the said ICP-CVD include an operating temperature of 100° C. to 200° C. and an operating pressure of 10 mT to 30 mT. Furthermore, the reaction gases used in the ICP-CVD include helium and silane (SiH₄) and a ratio of helium to silane ranges from 15:3 to 25:3. In a preferred embodiment, the preferred fabrication parameters for ICP-CVD include an operating temperature of 150° C., an operating pressure of 20 mT and a ratio of 20:3 for helium to silane.

In the present embodiment, after the formation of the channel layer 223, the fabrication method further comprises doping for the channel layer 223 to form an ohmic contact layer 223a on the surface of the channel layer 223. Thereafter, a conformal passivation layer 300, a planarization layer 310 and a substrate 320 are formed sequentially over the substrate 250. The fabrication methods for the three layers mentioned above have been extensively used by those skilled in the art. Hence, no further description thereof is provided.

In FIG. 3C and FIG. 4, according to the present embodiment, the fabrication process of the driving TFT 220 begins with the formation of the second gate 222, followed by the formation of the second source 224 and the second drain 226, resulting in the formation of the bottom gate type TFT as shown in FIG. 3C. However, in a preferred embodiment, the formation of the second source 224 and the second drain 226 can precede the formation of the second gate 222, resulting in the formation of the top gate type TFT as shown in FIG. 4. As mentioned above, employing a top gate driving TFT 220 can increase the fabrication tolerance of the contact 290.

Accordingly, the fabrication method of OLED begins with the formation of the transparent electrode, followed by the formation of the organic emitting layer to prevent the organic emitting layer from being damaged by the sputtering process for fabricating the transparent electrode. As a result, it is not necessary to form a gold film on the organic emitting layer and the light transmission rate of the OLED is retained. Since the fabrication method for the pixel structure of AMOLED display of the present invention comprises forming the TFT on the OLED, the pixel structure is bottom-emitting type. As a result, the light emitted by the OLED will not be obstructed by the TFT, greatly increasing the aperture ratio.

Although the present invention has been disclosed above by the preferred embodiments, they are not intended to limit the present invention. Anybody skilled in the art can make some modifications and alteration without departing from the spirit and scope of the present invention. Therefore, the protecting range of the present invention falls in the appended claims.

What is claimed is:

1. A fabrication method for a pixel structure of active matrix organic light emitting display (AMOLED), comprising:
(a) forming an organic light emitting diode (OLED) on a substrate, comprising a transparent electrode, an organic emitting layer and a reflective electrode, wherein the organic emitting layer is disposed between the transparent electrode and the reflective electrode; and
(b) forming at least one switching thin film transistor (switching TFT), at least one driving thin film transistor (driving TFT), a scan line, a data line and a storage capacitor over the substrate, wherein the switching TFT comprises a first gate, a first source and a first drain, and the first gate is coupled to the scan line, and the first source is coupled to the data line, wherein the driving TFT comprising a second gate, a second source and a second drain, and the second gate is coupled to the first drain, and wherein the storage capacitor is electrically connected to the first drain and the second gate, and the second drain is coupled to the reflective electrode.

2. The method of claim 1, wherein a fabrication method for forming a channel layer of the driving TFT and a channel layer of the switching TFT comprises:
fabricating a silicon layer by inductively coupled plasma chemical vapor deposition (ICP-CVD) ;and
crystallizing the silicon layer to form a polysilicon layer by excimer laser annealing (ELA).

3. The method of claim 2, wherein fabrication parameters for ICP-CVD comprise:
an operating temperature ranging from 100° C. to 200° C.;
an operating pressure ranging from 10 mT to 30 mT; and
reaction gases in a composition ratio of helium to silane ranging from 15:3 to 25:3.

4. The method of claim 1, prior to step (a), further comprising forming a color changing medium or a color filter on the substrate.

5. The method of claim 1, wherein the second gate is formed prior to forming the second source and the second drain.

6. The method of claim 1, wherein the second gate is formed after forming the second source and the second drain.

7. The method of claim 1, wherein the transparent electrode, the organic emitting layer and the reflective electrode are formed in sequence.

8. The method of claim 1, after step (a) and before step (b), further comprising forming an insulation layer on the substrate.

9. The method of claim 8, wherein the material of the insulation layer is benzocyclobutene (BCB).

10. The method of claim 8, wherein the step of forming the insulation layer comprises:
forming an insulation material layer over the substrate by spin coating; and
treating the insulation material layer with thermal curing.

11. The method of claim 8, prior to step (b), further comprising forming a buffer layer on the insulation layer.

12. The method of claim 11, wherein the material of the buffer layer is silicon nitride.

13. A pixel structure of an active matrix organic light emitting display, comprising:
a substrate;
an organic light emitting diode disposed on the substrate, comprising:
a transparent electrode;
an organic emitting layer; and
a reflective electrode, wherein the transparent electrode is disposed between the substrate and the organic emitting layer and the organic emitting layer is disposed between the transparent electrode and the reflective electrode;
a scan line disposed above the organic light emitting diode;
a data line disposed above the organic light emitting diode;
at least a switching TFT disposed above the organic light emitting diode, comprising a first gate, a first source and a first drain, wherein the first gate is coupled to the scan line and the first source is coupled to the data line;
at least one driving TFT disposed above the organic light emitting diode and comprising a second gate, a second source, a second drain, wherein the second gate is coupled to the first drain and the second drain is coupled to the reflective electrode; and
a storage capacitor disposed above the organic light emitting diode and electrically connected to the first drain and the second gate.

14. The pixel structure of claim 13, wherein a channel layer of the switching TFT and a channel layer of the driving TFT are formed of a polysilicon layer.

15. The pixel structure of claim 13, further comprising a color changing medium or a color filter disposed between the substrate and the transparent electrode.

16. The pixel structure of claim 13, wherein the second gate is disposed below and between the second source and the second drain.

17. The pixel structure of claim 13, wherein the second gate is disposed above and between the second source and the second drain.

18. The pixel structure of claim 13, further comprising an insulation layer disposed between the organic emitting layer and the driving TFT as well as between the reflective electrode and the driving TFT.

19. The pixel structure of claim 18, wherein the material of the insulation layer is benzocyclobutene (BCB).

20. The pixel structure of claim 18, further comprising a buffer layer disposed between the insulation layer and the driving TFT.

21. The pixel structure of claim 20, wherein the material of the buffer layer is silicon nitride.
